(19) United States
(12) Patent Application Publication
(10) Pub. No.: US 2012/0326992 A1
(43) Pub. Date: Dec. 27, 2012

(54) Touch Panel for Providing a Shield Against Noise

(75) Inventor: Ying-Jyh Yeh, Kaosiung City (TW)

(73) Assignee: Silicon Integrated Systems Corp., Hsinchu City (TW)

(21) Appl. No.: 13/170,177

(22) Filed: Jun. 27, 2011

(51) Int. Cl. G06F 3/041

(52) U.S. Cl. 345/173

(57) ABSTRACT

A touch panel includes a first substrate, first conductive circuits, second conductive circuits, and a shield circuit. The first conductive circuits are disposed on a first surface of the first substrate. Each of the first conductive circuits includes first electrodes. The second conductive circuits are disposed on the second first substrate. Each of the second conductive circuits includes second electrodes. The shield circuit is disposed on the second surface of the first substrate. The shield circuit for blocking out noise includes a transparent conducting layer and a conductive ring disposed on the transparent conducting layer. The conductive ring is electrically connected to a voltage supply.

### BACKGROUND OF THE INVENTION

1. Field of the Invention

The present invention relates to a touch panel, and more particularly, to a touch panel for providing a shield against noise.

2. Description of the Prior Art

Advanced displays have gradually become a major feature of today's consumer electronics products. To facilitate portability and utilization, a display device having a touch panel for users to touch directly have been widely used in television sets, smart phones or other electronics products.

For a conventional optical touch device, a large number of light sources and corresponding optical sensors are disposed around a liquid crystal display (LCD) panel. The optical sensors detect the light emitted by the corresponding light sources to determine the coordinate of the touch point. Such a design causes the volume of products to increase greatly though the light transmittance does not decrease accordingly. Due to this reason, the conventional optical touch device cannot meet the requirements for ordinary portable LCDs. As for a resistive touch panel or a capacitive touch panel, additional resistors or capacitors are disposed on the panel, and the coordinate of the touch point is determined by detecting voltage variations. However, because resistors, capacitors, or other components are disposed on the panel directly, the light transmittance of the LCD panel decreases, and the overall panel thickness increases as well.

Referring to FIG. 1 and FIG. 2, FIG. 1 is a structure diagram showing a conventional capacitive touch panel 10, and FIG. 2 is a cross-sectional view of a touch display device 1 comprising the capacitive touch panel 10 in FIG. 1 and a display panel 20. The capacitive touch panel 10 comprises transparent substrates 2 and 4, a cover lens 6, an X-axis conductive circuit 60 formed on the substrate 2 and arranged horizontally, and a Y-axis conductive circuit 70 formed on the substrate 4 and arranged vertically. Each of the X-axis conductive circuit 60 comprises a plurality of diamond-shaped X-axis electrodes 61 and a plurality of diamond-shaped Y-axis electrodes 71. Each of the Y-axis conductive circuit 70 comprises a plurality of diamond-shaped X-axis electrodes 61 and a plurality of diamond-shaped Y-axis electrodes 71, too. Any two adjacent X-axis electrodes 61 are electrically connected to each other through an X-axis conducting wire 62. Any two adjacent Y-axis electrodes 71 are electrically connected to each other through a Y-axis conducting wire 72. To avoid any short circuit occurs in the X-axis conductive circuit 60 and in the Y-axis conductive circuit 70, the X-axis conductive circuit 60 and the Y-axis conductive circuit 70 are formed on different substrates. The X-axis conductive circuit 60 is formed on the substrate 2, and the Y-axis conductive circuit 70 is formed on the substrate 4. The plurality of X-axis electrodes 61, the plurality of Y-axis electrodes 71, the X-axis conducting wire 62, and the Y-axis conducting wire 72 are formed by transparent conducting thin films such as indium tin oxide (ITO). The cover lens 6 protects the capacitive touch panel 10 from being exposed to the outer environment directly.

The touch panel 10 is glued to the display panel 20. The display panel 20 also has a conductive structure such as transparent conductive thin films. The noise generated by the display panel 20 in operation disturbs the sensing performance of the X-axis conductive circuit 60 or of the Y-axis conductive circuit 70. Thus, it requires the IT industry to design a new touch panel to reduce the influence of noise.

### SUMMARY OF THE INVENTION

According to the present invention, a touch panel comprises a first substrate comprising a first surface and a second surface opposite to the first surface, a plurality of first conductive circuits, disposed on the first surface of the first substrate, a plurality of second conductive circuits, disposed over the first surface of the first substrate, and a shield circuit disposed on the second surface of the first substrate. Each of the first conductive circuits comprises a plurality of first electrodes for sensing a first detecting current when an object is pressed down. Each of the second conductive circuits comprises a plurality of second electrodes for sensing a second detecting current when the object is pressed down. The shield circuit disposed on the second surface of the first substrate is used for blocking out noise, the shield circuit comprising a transparent conducting layer and a conductive ring disposed on the transparent conducting layer, the conductive ring electrically connected to a voltage supply.

In aspect of the present invention, the touch panel further comprises a second substrate disposed over the first substrate. The plurality of second conductive circuits are on the second substrate.

In aspect of the present invention, the touch panel device further comprises a flexible printed circuit board (FPC) and conducting wires disposed on the FPC. The conductive ring is a closed metallic ring electrically connected to the voltage supply through the conducting wires.

In aspect of the present invention, the touch panel device further comprises an FPC and a first conducting wire and a second conducting wire disposed on the FPC, wherein the conductive ring has a gap, two terminals of the gap of the conductive ring are connected to two voltage supplies through the first conducting wire and the second conducting wire on the FPC, respectively.

In one aspect of the present invention, the voltage supply is a direct-current (DC) voltage supply or is used for providing voltage applied on the first conductive circuit or the second conductive circuit.

In aspect of the present invention, each of the first conductive circuits is arranged along a first axis, each of the second conductive circuits is arranged along a second axis perpendicular to the first axis.

According to the present invention, a touch panel comprises a first substrate, a plurality of first conductive circuits disposed on the first substrate, a plurality of second conductive circuits disposed over the first substrate, and a plurality of shield circuits disposed on the first substrate and extending in a direction in parallel with an extending direction of the plurality of first conductive circuits. Each of the first conductive circuits comprises a plurality of first electrodes for sensing a first detecting current when an object is pressed down. Each of the second conductive circuits comprises a plurality of second electrodes for generating a second detecting current when the object is pressed down. Each of second conductive circuits extends in a direction crossing the extending direction of the plurality of first conductive circuits. Each of the shield circuits comprises a plurality of third electrodes and disposed between the two adjacent first conductive circuits, the plurality of shield circuits electrically connected to a voltage supply, for providing a shield against noise.

According to the present invention, a touch panel comprises a first substrate, a plurality of first conductive circuits disposed on the first substrate, a plurality of second conductive circuits disposed over the first substrate, a plurality of first shield circuits disposed on the first substrate and extending in a direction in parallel with an extending direction of the plurality of first conductive circuits, and a plurality of second shield circuits disposed on the first substrate and extending in a direction in parallel with the extending direction of the plurality of first conductive circuits. Each of the first shield circuits disposed between the two adjacent first conductive circuits is used for providing a shield against noise. Each of the second shield circuits disposed between the two adjacent first conductive circuits and symmetrical to one of the first shield circuits, is used for providing a shield against noise. Each of the first conductive circuits as well as the nearest first shield circuit and the nearest second shield circuit is electrically connected to a voltage supply.

Contrast to the prior art, the present invention comprises a touch panel and a display panel. The touch panel comprises a shield circuit disposed on the display panel for providing a shield against noise generated by the display panel, so that a detecting current flowing through a first conductive circuit or a second conductive circuit can be prevented from being disturbed by the noise generated by the display panel. Moreover, the shield circuit comprises a transparent conducting layer and a conductive ring thereon. The conductive ring is electrically connected to a voltage supply, so that the noise can be more effectively blocked out by the shield circuit.

These and other features, aspects and advantages of the present disclosure will become understood with reference to the following description, appended claims and accompanying figures.

### BRIEF DESCRIPTION OF THE DRAWINGS

FIG. 1 is a structure diagram showing a conventional capacitive touch panel.

FIG. 2 is a cross-sectional view of a touch display device comprising the capacitive touch panel in FIG. 1 and a display panel.

FIG. 3 is a structure diagram showing a capacitive touch panel according to a first embodiment of the present invention.

FIG. 4 is a cross-sectional view of a display panel comprising the capacitive touch panel in FIG. 3 and a display panel.

FIGS. 5A and 5B illustrate two embodiments of the transparent conducting layer and a conductive ring connected to an outer voltage terminal.

FIG. 6 is a top view of a capacitive touch panel according to a second embodiment of the present invention.

FIG. 7 shows a first conductive circuit and a shield circuit in FIG. 6.

FIG. 8 shows a second conductive circuit in FIG. 6.

FIG. 9 is a cross-sectional view of a touch display device comprising the capacitive touch panel in FIG. 6 and a display panel.

FIG. 10 is a top view of a capacitive touch panel according to a third embodiment of the present invention.

FIG. 11 shows a first conductive circuit and a first shield circuit, a second shield circuit in FIG. 10.

FIG. 12 shows a second conductive circuit in FIG. 10.

FIG. 13 is a cross-sectional view of a touch display device comprising the capacitive touch panel in FIG. 10 and a display panel.

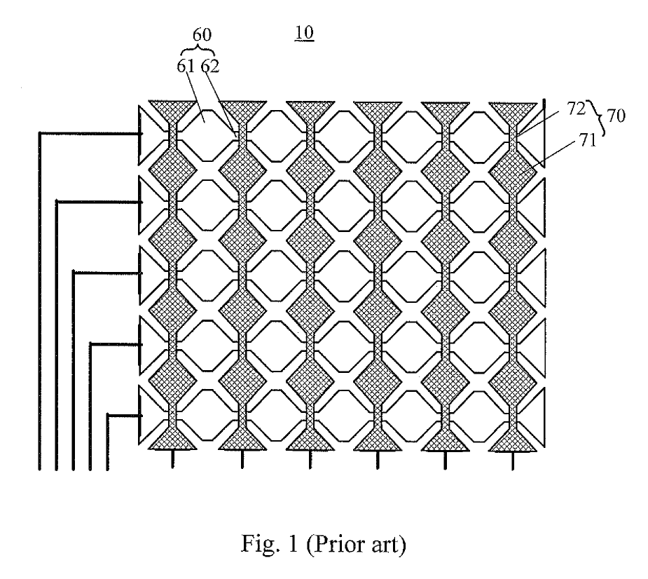

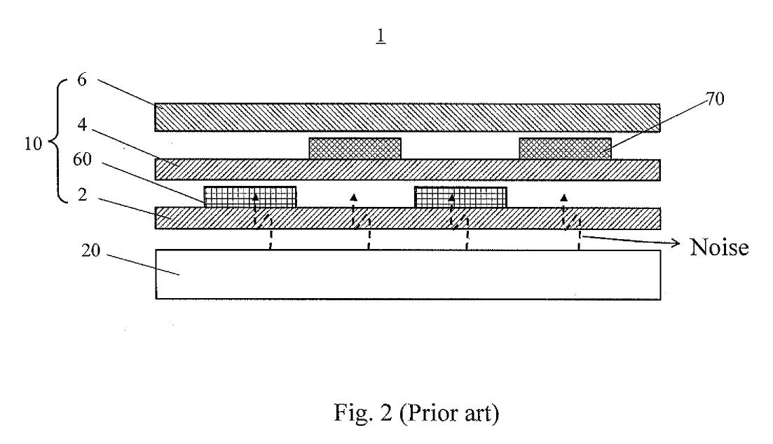

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

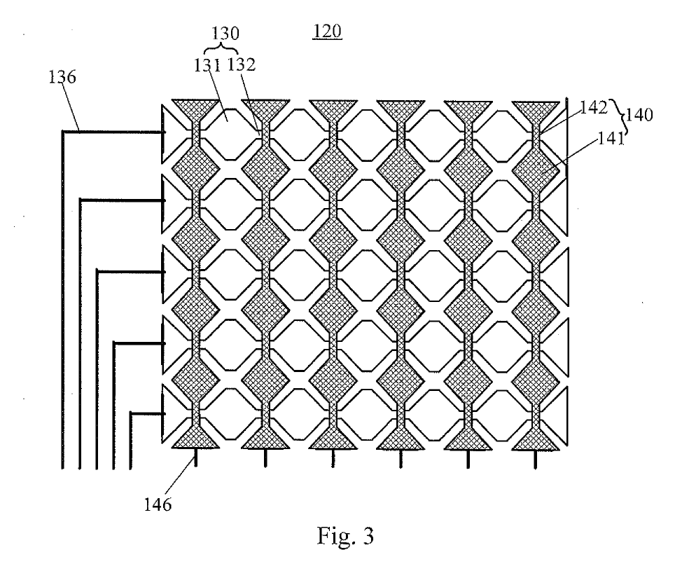

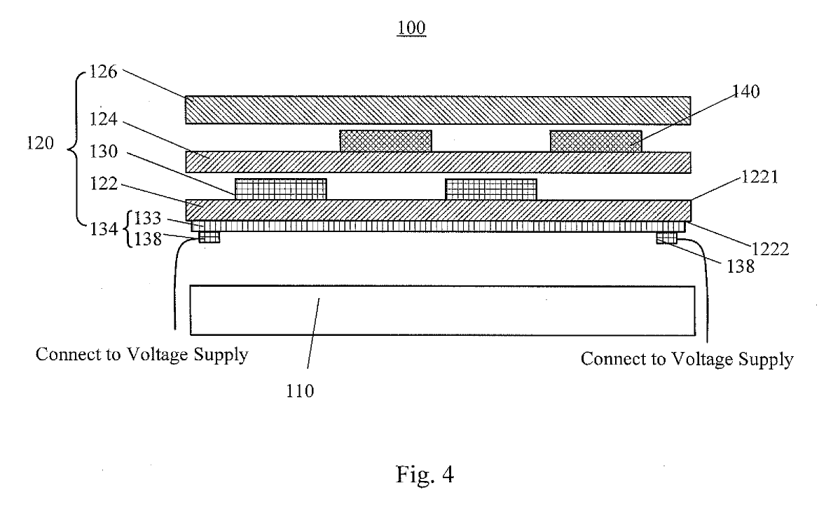

Referring to FIG. 3 and FIG. 4, FIG. 3 is a structure diagram showing a capacitive touch panel 120 according to a first embodiment of the present invention, and FIG. 4 is a cross-sectional view of a display panel 110 comprising the capacitive touch panel 120 in FIG. 3 and a display panel 110. The display panel 110 is, but not limited to, a liquid crystal display (LCD) panel. The display panel 110 comprises upper and lower substrates, a liquid crystal (LC) layer between the upper and lower substrates, and some optical components such as a polarizer film and a color filter. The conducting layer of the upper substrate is electrically connected to common voltage (Vcom). A plurality of pixel electrodes on the lower substrate are charged up to desired data voltage. According to the voltage difference between the data voltage and the common voltage (Vcom), the alignments of the LC molecules of each pixel electrode varies. The optical components and related operating principles used in the LCD panel 110 are commonly used and aware to the one skilled in this art. No more details are provided hereinafter.

The capacitive touch panel 120 comprises transparent substrates 122 and 124, a cover lens 126, a plurality of first conductive circuits 130 formed on the substrate 122, and a plurality of second conductive circuits 140 formed on the substrate 124. In another embodiment, the substrate 122 is removed, and the plurality of first conductive circuits 130 and the plurality of second conductive circuits 140 are formed on the substrate 124. The plurality of first conductive circuits 130 are arranged along a first axis, and the plurality of second conductive circuits 140 are arranged along a second axis. Preferably, the first axis is perpendicular to the second axis. Each of the first conductive circuits 130 comprises a plurality of diamond-shaped first electrodes 131. Each of the second conductive circuits 140 comprises a plurality of diamond-shaped second electrodes 141. Any two adjacent first electrodes 131 are electrically connected to each other through a first axis conducting wire 132. Any two adjacent second electrodes 141 are electrically connected to each other through a second axis conducting wire 142. To avoid any short circuit occurs between the plurality of first conductive circuits 130 and the plurality of second conductive circuits 140, the plurality of first conductive circuits 130 and the plurality of second conductive circuits 140 are formed on different substrates. The plurality of first conductive circuits 130 are formed on the substrate 122, and the plurality of second conductive circuits 140 are formed on the substrate 124. The transparent substrates 122 and 124 are made of glass or transparent macromolecule plates such as polycarbonate (PC) and polyvinyl chloride (PVC). The plurality of first electrodes 131, the plurality of second electrodes 141, the first axis conducting wire 132, and the second axis conducting wire 142 are formed by transparent conducting thin films such as ITO, aluminum zinc oxide (AZO), and indium zinc oxide (IZO). The plurality of first conductive circuits 130 are aligned along either X-axis or Y-axis perpendicular to the X-axis. Correspondingly to the plurality of first conductive circuits 130, the plurality of second conductive circuits 140 are aligned along either Y-axis or X-axis. According to the first embodiment, the plurality of first conductive circuits 130 are X-axis conductive circuits, and the plurality of second conductive circuits 140 are Y-axis conductive circuits. The cover lens 126 protects the capacitive touch panel 120 from being exposed to the outer environment directly. The cover lens 126 is a flexible transparent plate.

When a user's finger presses down on a point on the outer surface of the capacitive touch panel 120, static electricity in the user's body flows into the ground, and then a weak detecting current is produced. The detecting current passes through a first electrode 131 and a second electrode 141 corresponding to the touch point. The detecting current passing through the first electrode 131 and the second electrode 141 is transmitted to a detecting chip (not shown) through a metallic wire 136 and a metallic wire 146, respectively. Afterwards, the detecting chip determines the touch position according to the two flows of the detecting current. The detecting current is extremely weak so the outer noise has to be as little as possible in order to prevent the detecting chip from misjudging the detecting current.

As FIG. 3 shows, in addition to the plurality of first conductive circuits 130 disposed at a first surface 1221 of the substrate 122, there is a shield circuit 134 disposed at a second surface 1222. Preferably, the shield circuit 134 is a transparent conducting layer 133 covering the whole second surface 1222 and facing the display panel 110. The transparent conducting layer 133 conducts electricity, functioning as a metallic shield. So the transparent conducting layer 133 can provide a shield against noise and can further decrease the possibilities of misjudging the detecting current.

In another embodiment, the substrate 124 is removed. The first conductive circuits 130 and the second conductive circuits 140 are on one side 1221 of the substrate 122 while the shield circuits 134 are on an opposite side 1222 of the substrate 122, which is facing the display panel 110.

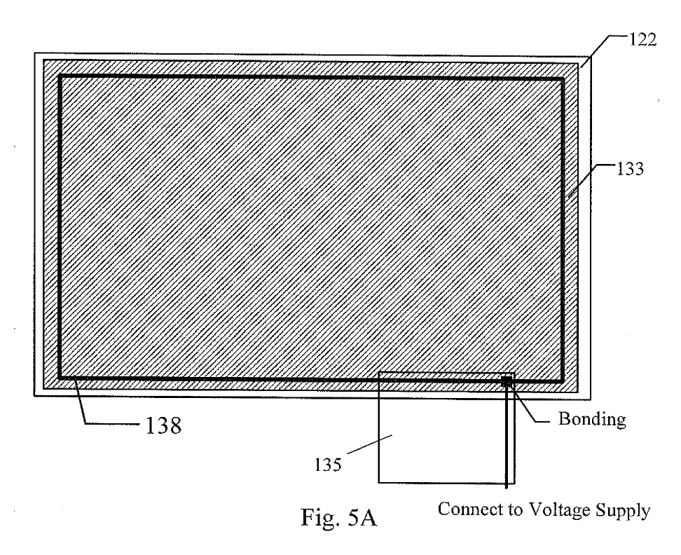

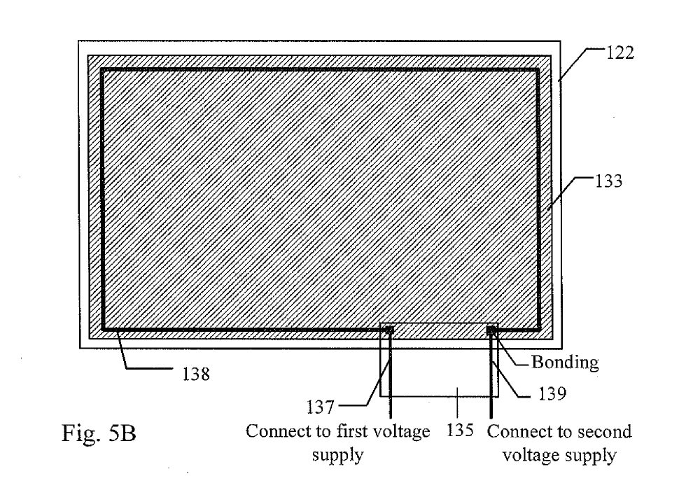

Referring to FIGS. 5A and 5B, FIGS. 5A and 5B illustrate two embodiments of the transparent conducting layer 133 and a conductive ring 138 connected to an outer voltage terminal. To enhance the shielding effect, the shield circuit 134 comprises a transparent conducting layer 133 and a conductive ring 138 thereon. The conductive ring 138 is made of metallic materials such as Au, Cu, Ag, Cr, Al, and Mo. The conductive ring 138 is connected to a voltage supply for providing a constant DC voltage such as a ground and the common voltage (Vcom) of the display panel 110 or to a voltage supply for providing the control voltage applied on the first conductive circuit 130 or the second conductive circuit 140. The conductive ring 138 is electrically connected to the transparent conducting layer 133, so noise, e.g. generated by the display panel 110, can be blocked out by the transparent conducting layer 133 and the conductive ring 138. Thus, the possibilities of misjudging the detecting current can be greatly decreased. As FIG. 5A shows, the conductive ring 138 is a closed metallic ring. The conductive ring 138 is connected to the constant DC voltage supply through a metallic wire 137 on a flexible printed circuit board (FPC) 135. As FIG. 5B shows, the conductive ring 138 is a metallic ring having a gap. Two terminals of the gap of the conductive ring 138 are connected to two DC voltage supplies through the metallic wire 137 and a metallic wire 139 on the FPC 135, respectively.

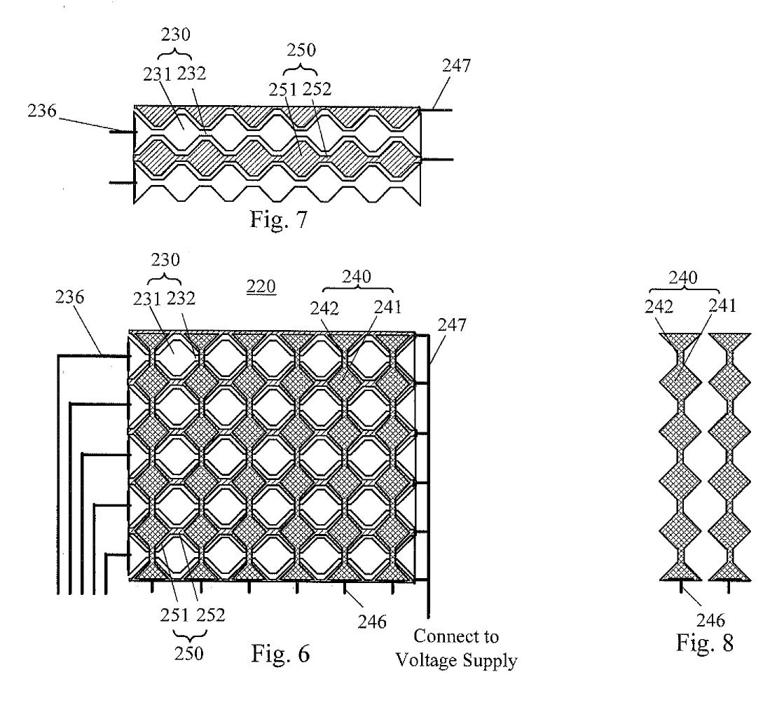

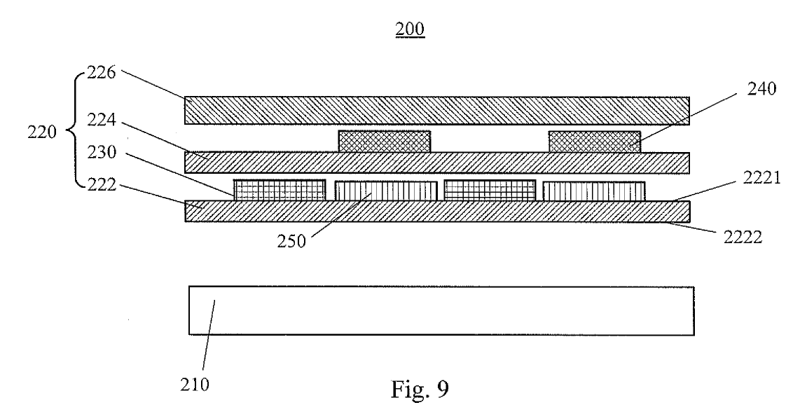

Please refer to FIGS. 6 to 9. FIG. 6 is a top view of a capacitive touch panel 220 according to a second embodiment of the present invention. FIG. 7 shows a first conductive circuit 230 and a shield circuit 250 in FIG. 6, and FIG. 8 shows a second conductive circuit 240 in FIG. 6. FIG. 9 is a cross-sectional view of a touch display device 200 comprising the capacitive touch panel 220 in FIG. 6 and a display panel 210. The capacitive touch panel 220 comprises transparent substrates 222 and 224, a cover lens 226, a plurality of first conductive circuits 230 and a plurality of shield circuits 250 formed on the substrate 222, and a plurality of second conductive circuits 240 formed on the substrate 224. The plurality of first conductive circuits 230 are arranged along a first axis, and the plurality of second conductive circuits 240 are arranged along a second axis. Preferably, the first axis is perpendicular to the second axis. Each of the first conductive circuits 230 comprises a plurality of diamond-shaped first electrodes 231. Each of the second conductive circuits 240 comprises a plurality of second electrodes 241. Any two adjacent first electrodes 231 are electrically connected to each other through a first axis conducting wire 232, and any two adjacent second electrodes 241 are electrically connected to each other through a second axis conducting wire 242. To avoid any short circuit occurs between the plurality of first conductive circuits 230 and the plurality of second conductive circuits 240, the plurality of first conductive circuits 230 and the plurality of second conductive circuits 240 are formed on different substrates. The plurality of first conductive circuits 230 are formed on the substrate 222, and the plurality of second conductive circuits 240 are formed on the substrate 224. In addition, the shield circuit 250 is also disposed on the substrate 222 and electrically connected to a voltage supply for providing DC voltage or control voltage applied on the first conductive circuits 230 or the second conductive circuit 240 via the wire 247. The shield circuit 250 comprises a plurality of diamond-shaped third electrodes 251. Any two adjacent third electrodes 251 are electrically connected to each other through a third axis conducting wire 252. As FIG. 6 shows, each of the third electrodes 251 is surrounded by neighboring four first electrodes 231. The transparent substrates 222 and 224 are made of glass or transparent macromolecule plates such as PC and PVC. The plurality of first electrodes 231, the plurality of second electrodes 241, the first axis conducting wire 232, the second axis conducting wire 242, the plurality of third electrodes 251, and the third axis conducting wire 252 are formed by transparent conducting thin films such as ITO, AZO, and IZO. The plurality of first conductive circuits 230 almost fit with the shield circuit 250. The plurality of first conductive circuits 230 are aligned with either an X-axis or a Y-axis. Correspondingly to the plurality of first conductive circuits 230, the plurality of second conductive circuits 240 are aligned with either the Y-axis or the X-axis. According to the second embodiment, the plurality of first conductive circuits 230 and the shield circuits 250 are aligned along the X-axis, and the plurality of second conductive circuits 240 are aligned with the Y-axis.

As shown in FIG. 9, the plurality of second conductive circuits 240 are disposed on the substrate 224, while the first conductive circuits 230 and the shield circuits 250 are disposed on the substrate 222. In another embodiment, the substrate 224 is removed. The first conductive circuits 230 and the second conductive circuits 240 are on one side 2221 of the substrate 222 while the shield circuits 250 are on an opposite side 2222 of the substrate 222, which is facing the display panel 210.

The plurality of third electrodes 251 on the shield circuit 250 are diamond-shaped, or can be polygonal, circular, oval, etc. The plurality of third electrodes 251 can still have other shapes as long as the space between the two first conductive circuits 230 is well filled. These variations are all within the spirit and scope of the present invention. The cover lens 226 protects the capacitive touch panel 220 from being exposed to the outer environment directly. The cover lens 226 is a flexible transparent plate.

When a user's finger presses down on a point on the outer surface of the capacitive touch panel 220, static electricity in the user's body flows into the ground, and then a weak detecting current is produced. The detecting current passes through a first electrode 231 and a second electrode 241 corresponding to the touch point. The detecting current passing through the first electrode 231 and the second electrode 241 is transmitted to a detecting chip (not shown) through a metallic wire 236 and a metallic wire 246, respectively. Afterwards, the detecting chip determines the touch position according to the detecting current. As FIG. 6 shows, the shield circuit 250 is connected to a DC voltage supply such as a ground and the common voltage (Vcom) of the display panel 210 via the wire 247 or to a voltage supply for providing voltage applied on the first conductive circuit 230 or the second conductive circuit 240, so noise, e.g. generated by the display panel 210, can be blocked out by the shield circuit 250. Thus, the possibilities of misjudging the detecting current can be greatly decreased.

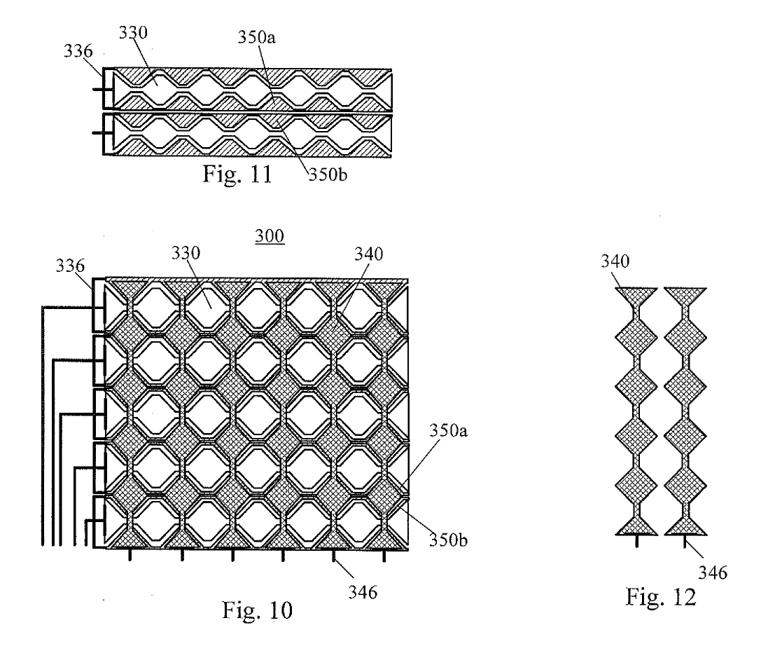

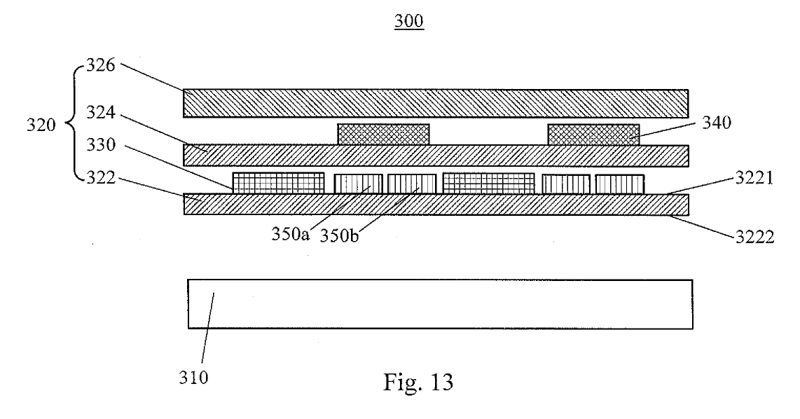

Please refer to FIGS. 10 to 13. FIG. 10 is a top view of a capacitive touch panel 320 according to a third embodiment of the present invention. FIG. 11 shows a first conductive circuit 330 and a first shield circuit 350a, a second shield circuit 350b in FIG. 10, FIG. 12 shows a second conductive circuit 340 in FIG. 10, and FIG. 13 is a cross-sectional view of a touch display device comprising the capacitive touch panel in FIG. 10 and a display panel.

Differing from the touch panel 220 shown in FIGS. 6 to 8, the touch panel 320 comprises the first conductive circuit 330, the first shield circuit 350a, the second shield circuit 350b disposed on the substrate 322, and the second conductive circuit 340 disposed on the substrate 324. In other words, the shield circuit 250 in FIG. 6 is divided into the first shield circuit 350a and the second shield circuit 350b. Both of the first shield circuit 350a and the second shield circuit 350b are symmetrical. The adjacent first shield circuit 350a and second shield circuit 350b are electrically connected to different voltage levels. Moreover, each of the first conductive circuits 330 as well as the nearest first shield circuit 350a and the nearest second shield circuit 350b is electrically connected to a control voltage via wires 336, so noise, e.g. generated by the display panel 310, can be blocked out by the first shield circuit 350a and the second shield circuit 350b. Thus, the possibilities of misjudging the detecting current can be greatly decreased. The cover lens 326 protects the capacitive touch panel 320 from being exposed to the outer environment directly. The cover lens 326 is a flexible transparent plate.

As shown in FIG. 13, the plurality of second conductive circuits 340 are disposed on the substrate 324, while the first conductive circuits 330, the first shield circuit 350a, and the second shield circuit 350b are disposed on the substrate 322. In another embodiment, the substrate 324 is removed. The first conductive circuits 330 and the second conductive circuits 340 are on one side 3221 of the substrate 322 while the shield circuit 350a and 350b are on an opposite side 3222 of the substrate 322, which is facing the display panel 310.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A touch panel, comprising:
a first substrate comprising a first surface and a second surface opposite to the first surface;
a plurality of first conductive circuits, disposed on the first surface of the first substrate, each of the first conductive circuits comprising a plurality of first electrodes;
a plurality of second conductive circuits, disposed over the first surface of the first substrate, each of the second conductive circuits comprising a plurality of second electrodes; and
a shield circuit disposed on the second surface of the first substrate, for blocking out noise, the shield circuit comprising a transparent conducting layer and a conductive ring disposed on the transparent conducting layer, the conductive ring electrically connected to a voltage supply.

2. The touch panel as claimed in claim 1 further comprising a second substrate disposed over the first substrate, wherein the plurality of second conductive circuits are on the second substrate.

3. The touch panel as claimed in claim 1 further comprising a flexible printed circuit board (FPC) and a conducting wire disposed on the FPC, wherein the conductive ring is a closed metallic ring electrically connected to the voltage supply through the conducting wire.

4. The touch panel as claimed in claim 1 further comprising an FPC and a first conducting wire and a second conducting wire disposed on the FPC, wherein the conductive ring has a gap, two terminals of the gap of the conductive ring are connected to two voltage supplies through the first conducting wire and the second conducting wire on the FPC, respectively.

5. The touch panel as claimed in claim 1, wherein each of the first conductive circuits is arranged along a first axis, each of the second conductive circuits is arranged along a second axis perpendicular to the first axis.

6. The touch panel as claimed in claim 1, wherein the voltage supply is a direct-current (DC) voltage supply or is used for providing voltage applied on the first conductive circuit or the second conductive circuit.

7. A touch panel, comprising:
a first substrate;
a plurality of first conductive circuits disposed on the first substrate, each of the first conductive circuits comprising a plurality of first electrodes;
a plurality of second conductive circuits, disposed over the first substrate, each of the second conductive circuits comprising a plurality of second electrodes, each of second conductive circuits extending in a direction crossing an extending direction of the plurality of first conductive circuits; and
a plurality of shield circuits, disposed on the first substrate and extending in a direction in parallel with the extending direction of the plurality of first conductive circuits, each of the shield circuits comprising a plurality of third electrodes and disposed between the two adjacent first conductive circuits, the plurality of shield circuits electrically connected to a voltage supply, for providing a shield against noise.

8. The touch panel as claimed in claim 7, wherein the first substrate comprises a first surface and a second surface opposite to the first surface, and the plurality of first conductive circuits and the plurality of second conductive circuits are disposed on the first surface, and the plurality of shield circuits are disposed on the second surface.

9. The touch panel as claimed in claim 7 further comprising a second substrate disposed over the first substrate, wherein the first substrate comprises a first surface and a second surface opposite to the first surface, and both of the plurality of first conductive circuits and the plurality of shield circuits are disposed on the first surface, while the plurality of second conductive circuits are on the second substrate.

10. The touch panel as claimed in claim 7, wherein each of the first conductive circuits is arranged along a first axis, and each of the second conductive circuits is arranged along a second axis perpendicular to the first axis.

11. The touch panel as claimed in claim 7, wherein the voltage supply is a direct-current (DC) voltage supply or is used for providing voltage applied on the first conductive circuit or the second conductive circuit.

12. A touch panel, comprising:
a first substrate;
a plurality of first conductive circuits, disposed on the first substrate, each of the first conductive circuits comprising a plurality of first electrodes;
a plurality of second conductive circuits, disposed over the first substrate, each of the second conductive circuits comprising a plurality of second electrodes, each of second conductive circuits extending in a direction crossing an extending direction of the plurality of first conductive circuits;
a plurality of first shield circuits, disposed on the first substrate and extending in a direction in parallel with the extending direction of the plurality of first conductive circuits, each of the first shield circuits disposed between the two adjacent first conductive circuits, for providing a shield against noise; and
a plurality of second shield circuits, disposed on the first substrate and extending in a direction in parallel with the extending direction of the plurality of first conductive circuits, each of the second shield circuits disposed between the two adjacent first conductive circuits and symmetrical to one of the first shield circuits, for providing a shield against noise,
wherein each of the first conductive circuits as well as the nearest first shield circuit and the nearest second shield circuit is electrically connected to a voltage supply.

13. The touch panel as claimed in claim 12, wherein the first substrate comprises a first surface and a second surface opposite to the first surface, the plurality of first conductive circuits and the plurality of second conductive circuits are disposed on the second surface, while the plurality of first shield circuits and the plurality of second shield circuits are disposed on the first surface.

14. The touch panel as claimed in claim 12, further comprising a second substrate disposed over the first substrate, wherein the first substrate comprises a first surface and a second surface opposite to the first surface, and the plurality of first conductive circuits, the plurality of first shield circuits, and the plurality of second shield circuits are disposed on the first surface, while the plurality of second conductive circuits are on the second substrate.

15. The touch panel as claimed in claim 12, wherein each of the first conductive circuits is arranged along a first axis, and each of the second conductive circuits is arranged along a second axis perpendicular to the first axis.

16. The touch panel as claimed in claim 12, wherein the voltage supply is a direct-current (DC) voltage supply or is used for providing voltage applied on the first conductive circuit or the second conductive circuit.
